(19) United States
(12) Patent Application Publication
(10) Pub. No.: US 2025/0008518 A1
(43) Pub. Date: Jan. 2, 2025

(54) CONTROL RESOURCE SET MAPPING DESIGN

(71) Applicant: QUALCOMM Incorporated, San Diego, CA (US)

(72) Inventors: Jing DAI, Beijing (CN); Changlong XU, Beijing (CN); Le LIU, San Jose, CA (US); Chao WEI, Beijing (CN)

(21) Appl. No.: 18/709,751

(22) PCT Filed: Jan. 7, 2022
(86) PCT No.: PCT/CN2022/070659

§ 371 Date: May 13, 2024

(51) Int. Cl. H04W 72/23; H04L 5/00; H04W 72/0453

(52) U.S. Cl. CPC H04W 72/23; H04L 5/0005; H04W 72/0453

(57) ABSTRACT

Certain aspects of the present disclosure provide techniques for wireless communication by a user equipment (UE), including receiving a physical broadcast channel (PBCH) that conveys a master information block (MIB) that configures a first control resource set (CORESET) within an operating bandwidth below a threshold bandwidth, determining, based on a mapping of time and frequency resources indicated in the MIB, physical resources within the first CORESET of one or more physical downlink control channel (PDCCH) candidates, and monitoring the one or more PDCCH candidates for a PDCCH with information scheduling a system information block (SIB).

### INTRODUCTION

Aspects of the present disclosure relate to wireless communications, and more particularly, to techniques for mapping resources of control channel candidates to resources of a control resource set.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

One aspect provides a method of wireless communication by a user equipment (UE), including receiving a physical broadcast channel (PBCH) that conveys a master information block (MIB) that configures a first control resource set (CORESET) within an operating bandwidth below a threshold bandwidth; determining, based on a mapping of time and frequency resources indicated in the MIB, physical resources within the first CORESET of one or more physical downlink control channel (PDCCH) candidates; and monitoring the one or more PDCCH candidates for a PDCCH with information scheduling a system information block (SIB).

One aspect provides a method of wireless communication by a network entity, including transmitting a PBCH that conveys a MIB that configures a CORESET within an operating bandwidth below a threshold bandwidth; determining, based on a mapping of time and frequency resources indicated in the MIB, physical resources within the first CORESET of one or more PDCCH candidates; and transmitting, to a UE in one or more of the PDCCH candidates, a PDCCH with information scheduling a SIB.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example of a base station and user equipment.

FIGS. 3A, 3B, 3C, and 3D depict various example aspects of data structures for a wireless communication network.

FIG. 4 illustrates example table for control resource set (CORESET) configuration.

FIG. 5 illustrates an example resource mapping, according to aspects of the present disclosure.

FIG. 6 depicts example CORESET locations in the frequency domain.

FIG. 7A depicts an example special CORESET (CORESET 0) not configured by radio resource control (RRC) signaling.

FIG. 7B depicts example control channel element (CCE) patterns.

FIG. 8 illustrates example physical downlink control channel (PDCCH) candidates for different aggregation levels (ALs).

FIG. 9 illustrates an example CORESET resource mapping.

FIG. 10A and FIG. 10B illustrate example reduced operating bandwidths.

FIG. 11 illustrates an example CORESET resource mapping.

FIG. 12 illustrates an example call flow diagram, in accordance with certain aspects of the present disclosure.

FIG. 13 illustrates example master information block (MIB) signaled fields that may be used to indicate CORESET resource mapping, in accordance with some aspects of the present disclosure.

FIG. 14A and FIG. 14B illustrate an example of MIB signaled fields and corresponding CORESET resource mapping, in accordance with some aspects of the present disclosure.

FIG. 15A and FIG. 15B illustrate an example of MIB signaled fields and corresponding PDCCH candidates, in accordance with some aspects of the present disclosure.

FIG. 16 illustrates an example CORESET resource mapping, in accordance with certain aspects of the present disclosure.

FIGS. 17 and 18 depict example processes of wireless communication according to aspects of the present disclosure.

FIGS. 19 and 20 depict example communication devices according to aspects of the present disclosure.

### DETAILED DESCRIPTION

Aspects of the present disclosure provide apparatuses, methods, processing systems, and computer-readable mediums for mapping control channel candidates to resources of a control resource set. For example, the techniques presented herein may be used to map physical downlink control channel (PDCCH) candidates to resources of a CORESET that is configured via broadcast signaling rather than radio resource control (RRC) signaling, referred to as CORESET 0.

A CORESET generally refers to a set of physical resources (e.g., resources on a time and frequency grid) that is used to transmit a physical downlink control channel (PDCCH) carrying downlink control information (DCI) in 5G new radio (NR) systems. In NR, a user equipment (UE) is typically signaled frequency location and frequency domain width (the CORESET size) via RRC signaling or broadcast signaling.

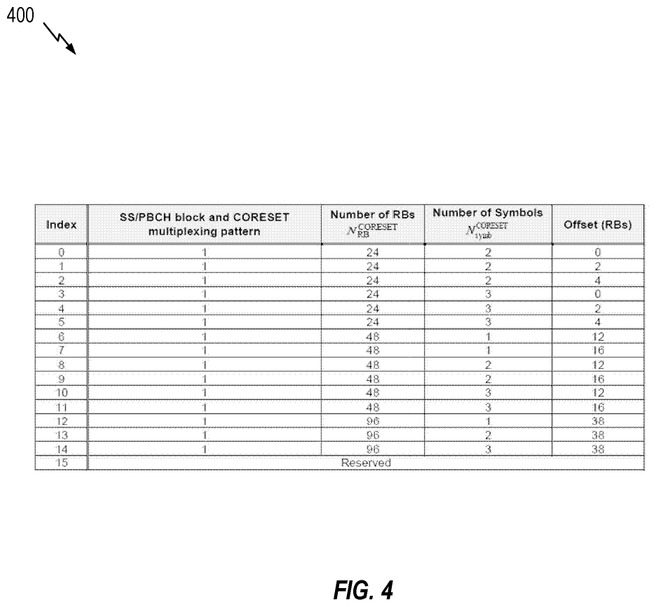

CORESET 0 may be considered a special CORESET because this CORESET is used for transmitting PDCCH for system information block (SIB) scheduling before RRC signaling is transmitted. Thus, CORESET 0 is typically configured by some predefined process and predefined parameters. In current systems, CORESET 0 is configured via broadcast signaling, by a set of bits in a master information block (MIB) conveyed via a physical broadcast channel (PBCH). For example, 4 bits of an 8-bit parameter PDCCH-ConfigSIB1 in MIB may be used as an index into a table, as illustrated in table 400 of FIG. 4, with parameters for configuring CORESET 0. As illustrated, the parameters to configure CORESET 0 may include a number of symbols in the time domain, the location (in terms of an offset number of RBs), and size (in terms of number of RBs).

As illustrated in FIG. 4, in typical systems CORESET 0 width is at least 24 resource blocks (RBs). However, various use cases may benefit from greater flexibility in CORESET width and configuration. For example, railway system and other dedicated system applications that have limited spectrum (e.g., a smart grid private network) may use a narrow operating bandwidth than the standard 5 MHz NR operating bandwidth. In such cases, 4 MHz, 3 MHz, or even smaller bandwidth may be used. As a result, smaller subcarrier spacings (SCS) may be used and CORESET 0 widths of less than 24 RBs may be desirable (e.g., 20 RBs, 16 RBs, or less).

Using the current minimum CORESET 0 width of 24 RBs would result in a waste of resources. Further, existing mechanisms to map resources (control channel elements or CCEs) of PDCCH candidates to CORESET 0 resources (resource element groups or REGs) is based on interleaving that assumes fixed values for REG bundle size and interleaving depth. This may result in CCEs of some PDCCH candidates being mapped outside of system bandwidth. This mapping of CCEs for certain PDCCH candidates may effectively eliminate these as valid candidates and reduce the actual aggregation level (AL) supported, which may degrade the reliability of the common PDCCH in CORESET 0 and overall system performance.

Aspects of the present disclosure provide flexible mechanisms for configuring CORESET 0. As will be described in greater detail below, in some cases, fields in a MIB may be reinterpreted by UEs when operating in certain operating bandwidths (e.g., less than 5 MHz). These fields may be used to indicate CORESET 0 sizes of less than 24 RBs and may also enable flexibility to indicate parameters that determine how to map resources of PDCCH candidates to CORESET 0 resources (e.g., CCE-to-REG mapping). Thus, the techniques presented herein may result in more efficient use of system resources and improved system performance.

### Introduction to Wireless Communication Networks

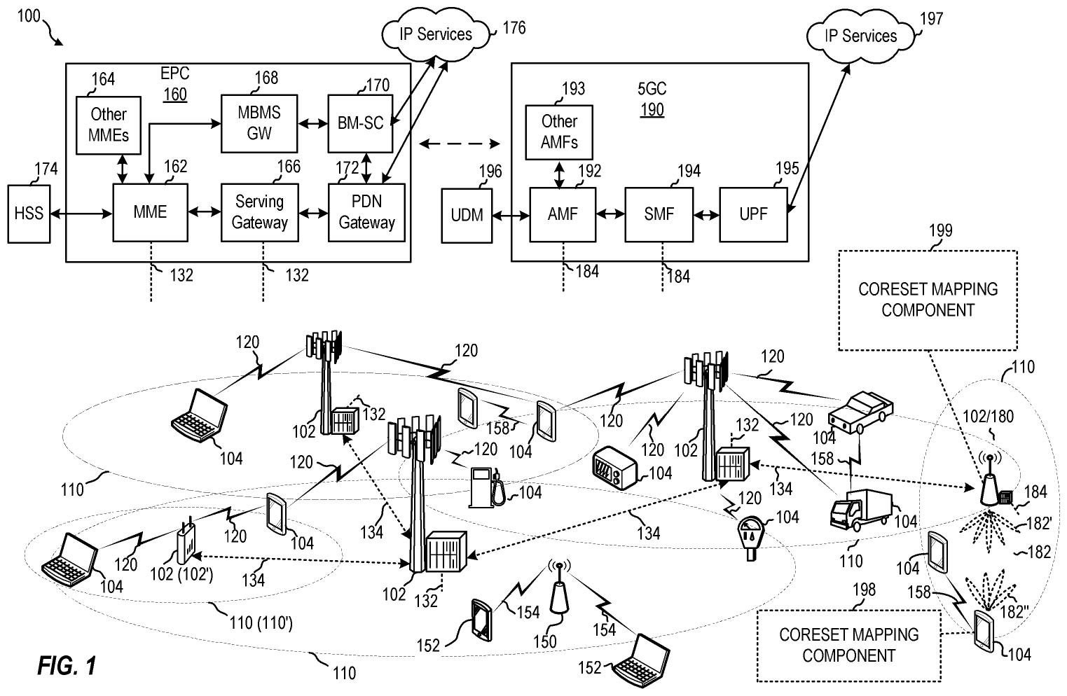

FIG. 1 depicts an example of a wireless communication network 100, in which aspects described herein may be implemented.

Generally, wireless communication network 100 includes base stations (BSs) 102, user equipments (UEs) 104, one or more core networks, such as an Evolved Packet Core (EPC) 160 and 5G Core (5GC) network 190, which interoperate to provide wireless communications services.

BSs 102 may provide an access point to the EPC 160 and/or 5GC 190 for a UE 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a gNB, NodeB, eNB, ng-eNB (e.g., an eNB that has been enhanced to provide connection to both EPC 160 and 5GC 190), an access point, a base transceiver station, a radio base station, a radio transceiver, or a transceiver function, or a transmission reception point in various contexts.

A base station, such as BS 102, may include components that are located at a single physical location or components located at various physical locations. In examples in which the base station includes components that are located at various physical locations, the various components may each perform various functions such that, collectively, the various components achieve functionality that is similar to a base station that is located at a single physical location. As such, a base station may equivalently refer to a standalone base station or a base station including components that are located at various physical locations or virtualized locations. In some implementations, a base station including components that are located at various physical locations may be referred to as or may be associated with a disaggregated radio access network (RAN) architecture, such as an Open RAN (O-RAN) or Virtualized RAN (VRAN) architecture. In some implementations, such components of a base station may include or refer to one or more of a central unit (CU), a distributed unit (DU), or a radio unit (RU).

BSs 102 wirelessly communicate with UEs 104 via communications links 120. Each of BSs 102 may provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, base station 180 and the UE 104 may each include a plurality of antennas, such as antenna elements, antenna panels, and/or antenna arrays to facilitate the beamforming.

In some cases, base station 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. Base station 180 may also receive the beamformed signal from UE 104 in one or more receive directions 182′. Base station 180 and UE 104 may then perform beam training to determine the best receive and transmit directions for each of base station 180 and UE 104. Notably, the transmit and receive directions for base station 180 may or may not be the same. Similarly, the transmit and receive directions for UE 104 may or may not be the same.

Wireless communication network 100 includes CORESET mapping component 199, which may configure one or more aspects of CORESET resources and CORESET monitoring by UE 104. Wireless communication network 100 further includes CORESET mapping component 198, which may be used to monitor for PDCCH candidates in a configured CORESET.

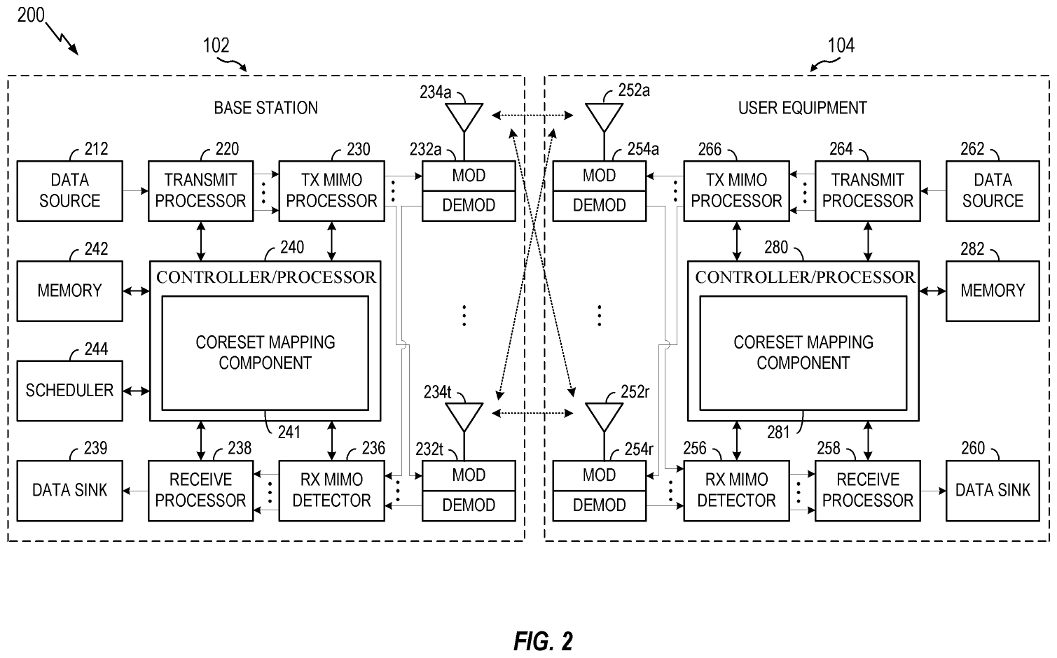

FIG. 2 depicts aspects of an example BS 102 and a UE 104. Generally, BS 102 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, BS 102 may send and receive data between itself and UE 104.

BS 102 includes controller/processor 240, which may be configured to implement various functions related to wireless communications. In the depicted example, controller/processor 240 includes CORESET mapping component 241, which may be representative of CORESET mapping component 199 of FIG. 1. Notably, while depicted as an aspect of controller/processor 240, CORESET mapping component 241 may be implemented additionally or alternatively in various other aspects of BS 102 in other implementations.

Generally, UE 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., data source 262) and wireless reception of data (e.g., data sink 260).

UE 104 includes controller/processor 280, which may be configured to implement various functions related to wireless communications. In the depicted example, controller/processor 280 includes CORESET mapping component 281, which may be representative of CORESET mapping component 198 of FIG. 1. Notably, while depicted as an aspect of controller/processor 280, CORESET mapping component 281 may be implemented additionally or alternatively in various other aspects of UE 104 in other implementations.

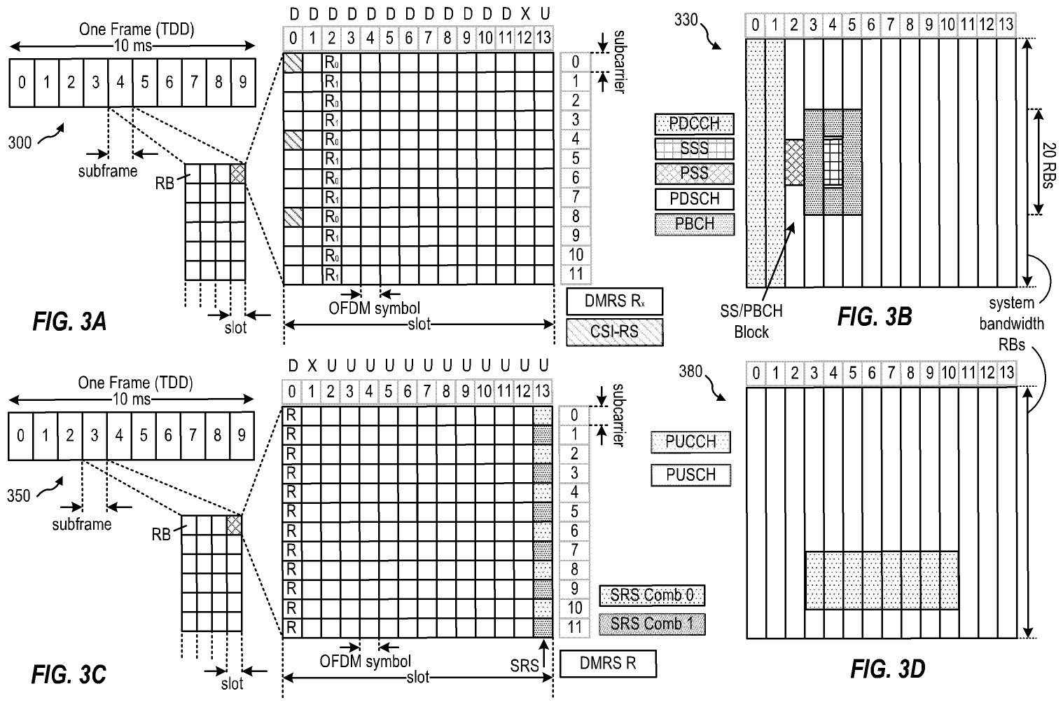

FIGS. 3A, 3B, 3C, and 3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, and FIGS. 3A, 3B, 3C, and 3D are provided later in this disclosure.

Introduction to mmWave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

5G networks may utilize several frequency ranges, which in some cases are defined by a standard, such as the 3GPP standards. For example, 3GPP technical standard TS 38.101 currently defines Frequency Range 1 (FR1) as including 600 MHZ-6 GHZ, though specific uplink and downlink allocations may fall outside of this general range. Thus, FR1 is often referred to (interchangeably) as a “Sub-6 GHz” band.

Similarly, TS 38.101 currently defines Frequency Range 2 (FR2) as including 26-41 GHz, though again specific uplink and downlink allocations may fall outside of this general range. FR2, is sometimes referred to (interchangeably) as a “millimeter wave” (“mmW” or “mmWave”) band, despite being different from the extremely high frequency (EHF) band (30 GHz-300 GHz) that is identified by the International Telecommunications Union (ITU) as a “millimeter wave” band because wavelengths at these frequencies are between 1 millimeter and 10 millimeters.

Communications using mmWave/near mmWave radio frequency band (e.g., 3 GHZ-300 GHz) may have higher path loss and a shorter range compared to lower frequency communications. As described above with respect to FIG. 1, a base station (e.g., 180) configured to communicate using mmWave/near mmWave radio frequency bands may utilize beamforming (e.g., 182) with a UE (e.g., 104) to improve path loss and range.

### Overview of Signal Synchronization Block Transmission

In NR, a synchronization signal block (SSB) is transmitted. In certain aspects, SSBs may be transmitted in a burst where each SSB in the burst corresponds to a different beam direction for UE-side beam management (e.g., including beam selection and/or beam refinement). The SSB includes a PSS, a SSS, and a two symbol PBCH. The SSB can be transmitted in a fixed slot location, such as the symbols 2-5 as shown in FIG. 3B. The PSS and SSS may be used by UEs for cell search and acquisition. The PSS may provide half-frame timing, the SS may provide the CP length and frame timing. The PSS and SSS may provide the cell identity. The PBCH carries some basic system information, such as downlink system bandwidth, timing information within radio frame, SS burst set periodicity, system frame number, etc. The SSBs may be organized into SS bursts to support beam sweeping. Further system information such as, remaining minimum system information (RMSI), system information blocks (SIBs), other system information (OSI) can be transmitted on a physical downlink shared channel (PDSCH) in certain subframes. The SSB can be transmitted up to sixty-four times, for example, with up to sixty-four different beam directions for mmWave. The multiple transmissions of the SSB are referred to as a SS burst set. SSBs in an SS burst set may be transmitted in the same frequency region, while SSBs in different SS bursts sets can be transmitted at different frequency regions.

Further system information such as, remaining minimum system information (RMSI), system information blocks (SIBs), other system information (OSI) can be transmitted on a physical downlink shared channel (PDSCH) in certain subframes.

The SSBs may be organized into SS burst sets to support beam sweeping. As shown, each SSB within a burst set may be transmitted using a different beam, which may help a UE quickly acquire both transmit (Tx) and receive (Rx) beams (e.g., in certain mmW applications). A physical cell identity (PCI) may still be decoded from the PSS and SSS of the SSB.

Certain deployment scenarios may include one or both NR deployment options. Some may be configured for non-standalone (NSA) and/or standalone (SA) option. A standalone cell may need to broadcast both SSB and remaining minimum system information (RMSI), for example, with SIB1 and SIB2. A non-standalone cell may only need to broadcast SSB, without broadcasting RMSI. In a single carrier in NR, multiple SSBs may be sent in different frequencies, and may include the different types of SSB.

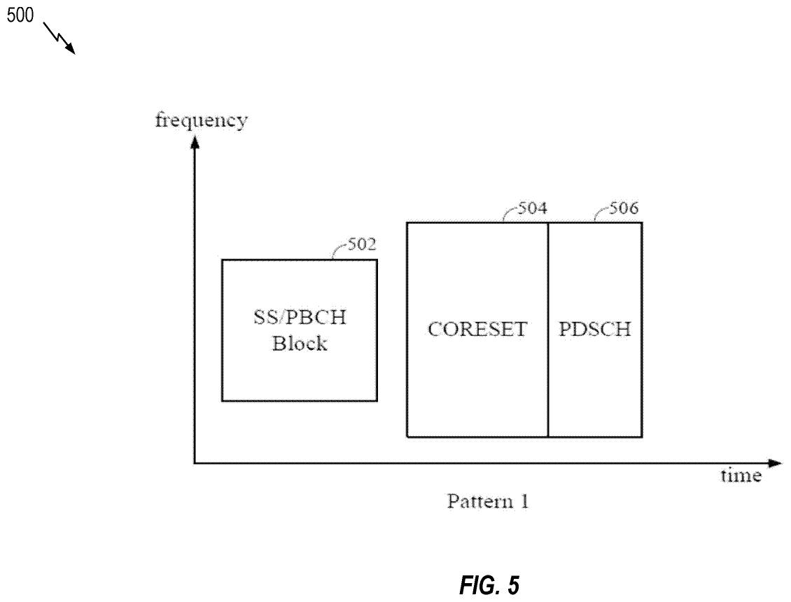

FIG. 5 shows an exemplary transmission resource mapping 500, according to aspects of the present disclosure. In the exemplary mapping, a BS (e.g., BS 110a, shown in FIG. 1) transmits an SS/PBCH block 502. The SS/PBCH block includes a master information block (MIB) conveying an index to a table that relates the time and frequency resources of the CORESET 504 to the time and frequency resources of the SS/PBCH block. The BS may also transmit control signaling. In some scenarios, the BS may also transmit a PDCCH within time/frequency resources of CORESET 504 (e.g., scheduling a PDSCH 506) to a UE.

### Overview of Control Resource Sets

As noted above, a CORESET generally refers to a set of physical (time and frequency) resources that is used to transmit a PDCCH carrying downlink control information (DCI). In NR, a user equipment (UE) is typically signaled frequency location and frequency domain width (the CORESET size) via RRC signaling.

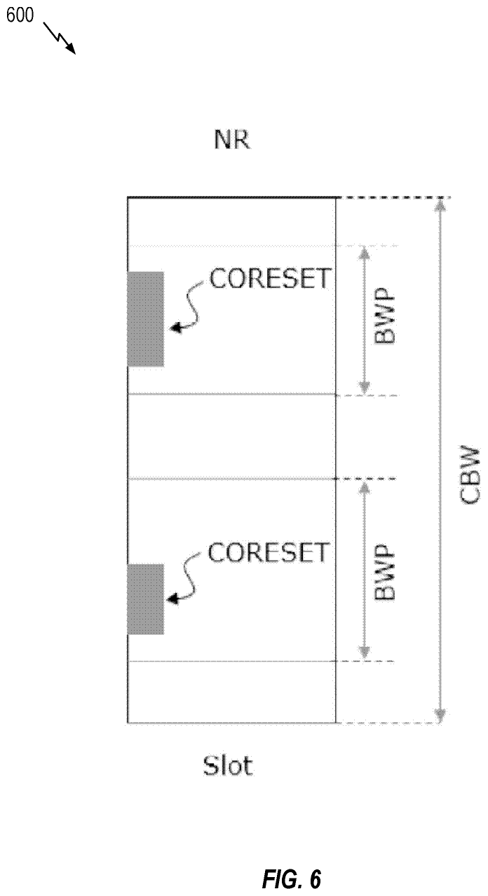

A CORESET in NR is analogous to the control region in LTE. While the control region in LTE is spread across the whole channel band width (CBW), the CORESET in NR CORESET is localized within a bandwidth part (BWP), as illustrated in diagram 600 of FIG. 6. Because of this, NR uses a frequency domain parameter defining the frequency domain width (in number of RBs) for CORESET since the frequency domain width can be set in any value in the multiples of six RBs. NR also uses a parameter for the time domain length (e.g., a number of symbols).

A UE may be configured with up to three CORESETs on each of up to four BWPs on a serving cell, for up to 12 CORESETs on a serving cell in total. Each CORESET has an index of 0-11. In general, CORESETs are configured in units of six PRBs on a six PRB frequency grid (starting from a reference point referred to as point A) and one, two, or three consecutive OFDM symbols in the time domain (as shown in the table 400 of FIG. 4).

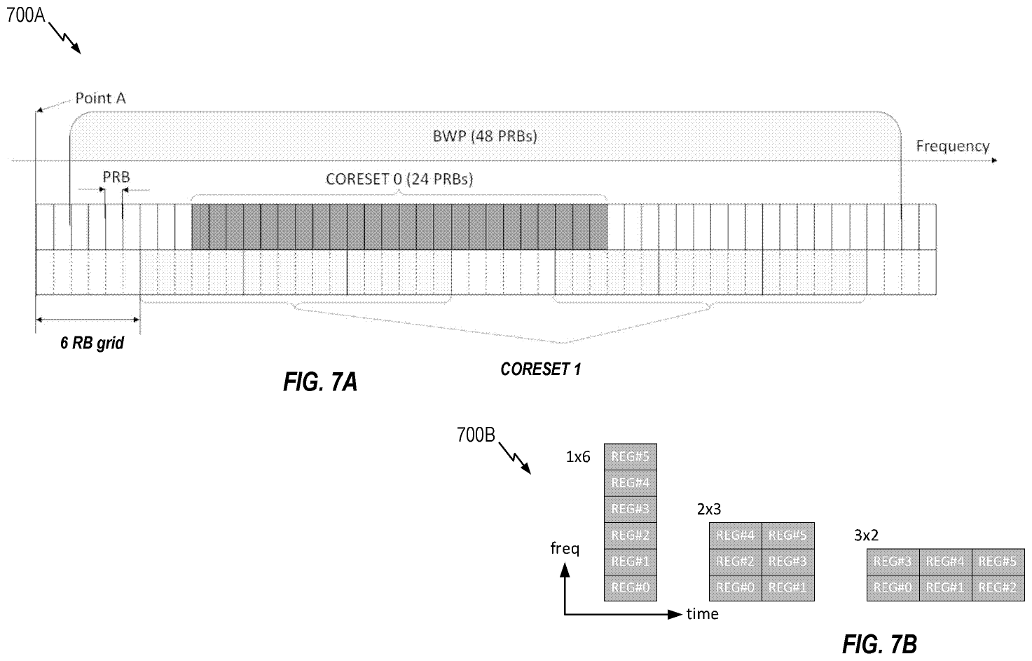

As noted above, CORESET 0 (CORESET with index 0) may be configured using a four-bit field in the MIB. Thus, a UE may acquire CORESET 0 before higher-layer (RRC) CORESET configurations are provided, albeit with a limited number of combinations of parameters compared to CORESETs with indices other than 0. An example of a 24 RB CORESET 0, located within a 48 RB BWP, is shown in diagram 700A FIG. 7A. As shown, while other CORESETS (CORESET 1) may need to be aligned with a six PRB frequency grid, CORESET 0 may not be so aligned, since the frequency-domain resource of CORESET 0 is determined relatively with the SSB.

A CORESET structure may accommodate different numbers of PDCCH candidates, corresponding to different aggregation levels (ALs). A PDCCH candidate generally refers to a specific set of candidate physical resources that a UE has to monitor (collectively referred to as a Search Space) for a PDCCH transmission of DCI with scheduling information.

The CORESET structure may be understood with reference to the following elements. A resource element (RE) generally refers to the smallest unit of the (time/frequency) resource grid made up of one subcarrier in frequency domain and one OFDM symbol in time domain. An RE group (REG) generally refers to one resource block (RB, typically 12 REs) in the frequency domain and one OFDM symbol in time domain.

A control-channel element (CCE) is generally formed by multiple (e.g., 6) REGs. As shown in diagram 700B FIG. 7B, the REGs in a CCE may be formed according to various time and frequency patterns (1 symbol×6 REGs, 2 symbols×3 REGs, or 3 symbols×2 REGs). An REG bundle (used for interleaving purposes) is formed of multiple REGs. The REG bundle size is specified by the parameter ‘L’ (and often indicated by the RRC parameter REG-bundle-size at least for CORESETs other than CORESET 0). The number REG bundles within a CCE varies. A PDCCH candidate represents a potential PDCCH for the UE to monitor within a CORESET, defined with a starting CCE index, and number of CCEs with consecutive CCE indexes.

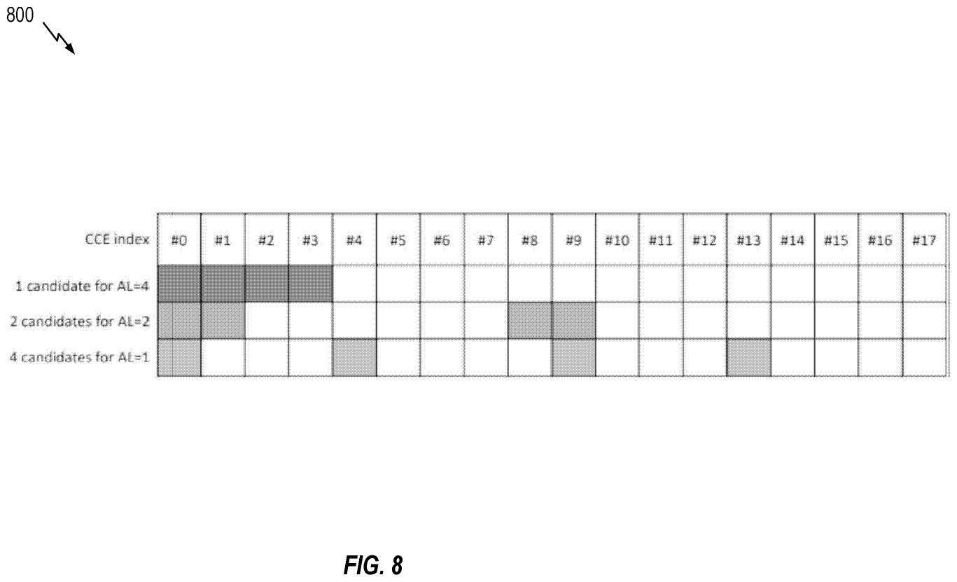

Aggregation level generally refers to how many CCEs are allocated for a PDCCH. Thus, any given CORESET size may support a limited number of PDCCH candidates based on the aggregation level. Diagram 800 of FIG. 8 illustrates how a CORESET may support 1 PDCCH candidate for aggregation level 4 (AL 4, 4 CCEs), 2 PDCCH candidates for aggregation level 2 (AL 2, 2 CCEs), and 4 PDCCH candidates for aggregation level 1 (AL 1, 1 CCE). A UE configured with such a CORESET may, thus, need to monitor for each of these different types of PDCCH candidates (7 total).

As shown in FIG. 8, PDCCH candidates are formed of CCEs identified by CCE indices. For actual transmission, CCEs of PDCCH candidates may be mapped to REGs of the CORESET. The CCE-to-REG mapping for a CORESET can be non-interleaved or interleaved. Non-interleaved CCE-to-REG mapping may be used in some cases (e.g., for localized beamforming) and generally involves mapping CCEs to REGs in index order. Non-interleaved CCE-to-REG mapping may be used in some cases (e.g., to achieve frequency diversity by spreading different parts of a PDCCH across CORESET frequency) and generally involves mapping CCEs to REGs out of order, according to some mapping pattern based on REG bundle size (L) and an interleaving depth (R). Interleaving depth generally refers to how widely REG bundles of CCEs are distributed on the frequency domain over the entire CORESET bandwidth.

An REG bundle is generally the interleaving unit used for CCE-to-REG mapping (if CCE-to-REG interleaving is configured for a CORESET). The bundle size (L) can be {2,3,6}. Conventional CCE-to-REG mapping for CORESET 0 assumes an REG bundles size of 6 (L=6) and an interleaving depth of 2 (R=2). In general, for a CORESET with 1 or 2 symbol(s), LE {2,6}, while for a CORESET with 3 symbols, LE {3,6}. An interleaving size RE {2,3,6} can be configured such that a CORESET should have an integer multiples of L*R REGs.

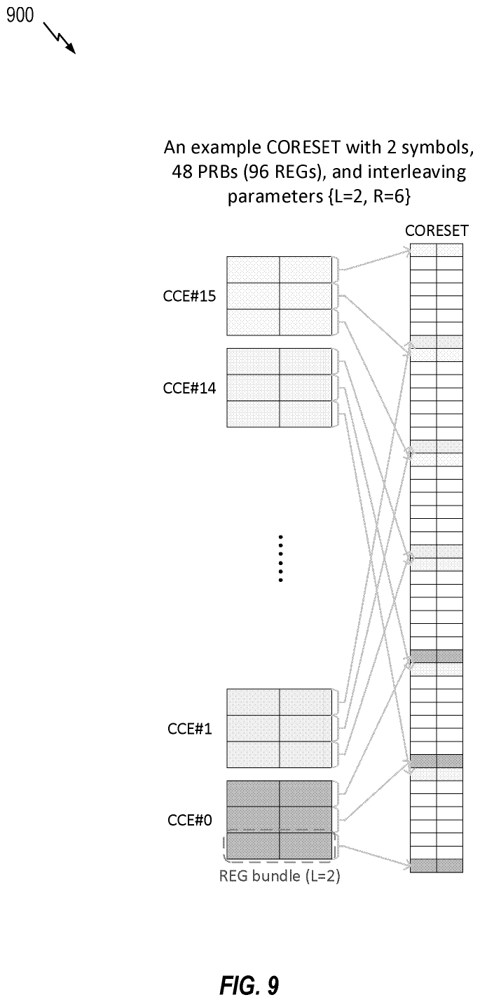

FIG. 9 illustrates a diagram 900 of one example of CCE-to-REG interleaving for an example CORESET with 2 symbols, 48 PRBs (96 REGs), and interleaving parameters {L=2, R=6} (not CORESET 0, given L=2). In the illustrated example, with L=2, an REG bundle (2 REGs) of each CCE is mapped to CORESET REGs, and REG bundles of consecutive CCEs are spread across the CORESET bandwidth according to the interleaving depth.

### Example Impact of Reduced Operating Bandwidth on Control Resource Set Resource Utilization

In some cases, the default CCE-to-REG mapping for CORESET 0 may be less than ideal, particularly given the conventional CORESET 0 minimum size of 24 RBs. For example, use cases involving narrower operating bandwidth than the standard 5 MHz NR operating bandwidth, may benefit from more flexible CORESET 0 configuration.

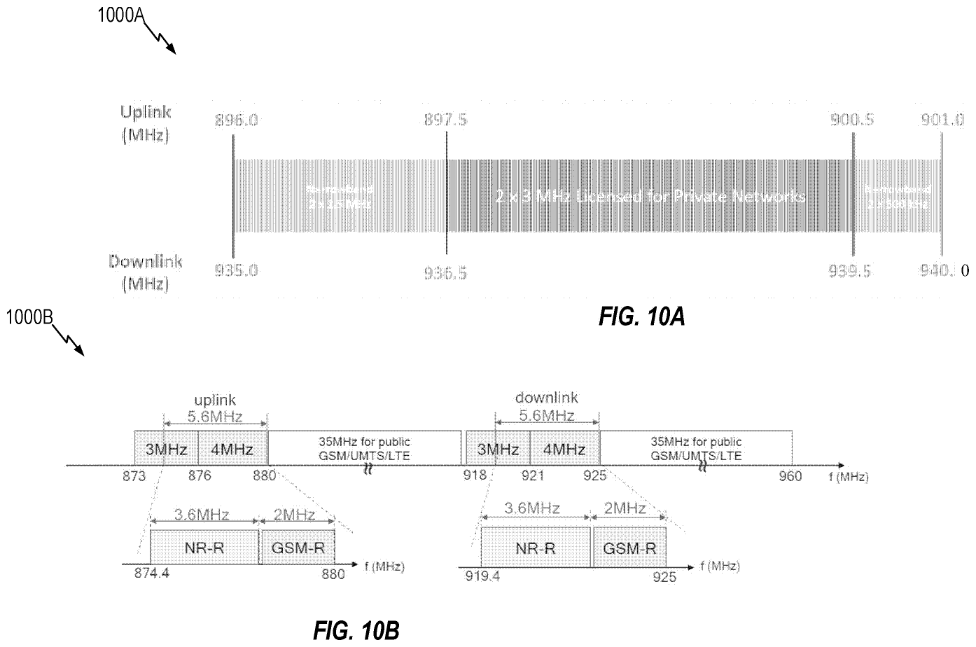

For example, as illustrated by diagram 1000A in FIG. 10A, relatively narrow bandwidths (e.g., BW<5 MHZ) may be used for frequency division duplexing (FDD) in rail applications (that may require a relatively large number of base stations spaced along a known path). In the example shown in FIG. 10A, 5 MHz bandwidth may be partitioned in to two 1.5 MHz FDD bands (896-897.5 MHz for uplink and 935-965 MHz for downlink) and two 3 MHz FDD bands (897.5-900.5 MHz for uplink and 936.5-939.5 MHz for downlink) licensed for private networks, and 2 additional 500 kHz bands (900.5-901 MHz for uplink and 939.5-940 MHz for downlink). Diagram 1000B of FIG. 10B illustrates another example, where two Global System for Mobile Communications for Rail (GSM-R) 4 MHz bands and two extended (E) GSM-R 3 MHz bands (7 MHz total) may be partitioned to be shared by NR for railway (NR-R) as two 3.6 MHz bands and two 2 MHz GSM-R bands. These are just examples, and dedicated systems (NR or otherwise) with even smaller bandwidth may be used, with actual bandwidth depending on various factors, such as how many GSM-R carriers are to be preserved.

In such applications, using reduced bandwidths, a full range of subcarrier spacings (SCS) may not be necessary. For example, it may be sufficient to support only 15 kHz SCS (180 kHz per RB, given 12 REs per RB). This may mean fewer RBs for a CORESET, such as less than 16 RBs for 3 MHz BW or 20 RBs for 3.6 MHz BW. Existing CORESET 0 configurations may not suffice, given current CORESET 0 minimum width is 24 RBs. Various reference signals (RS), such as channel state information (CSI) RS and tracking reference signals (TRS) currently also span at least 24 RBs.

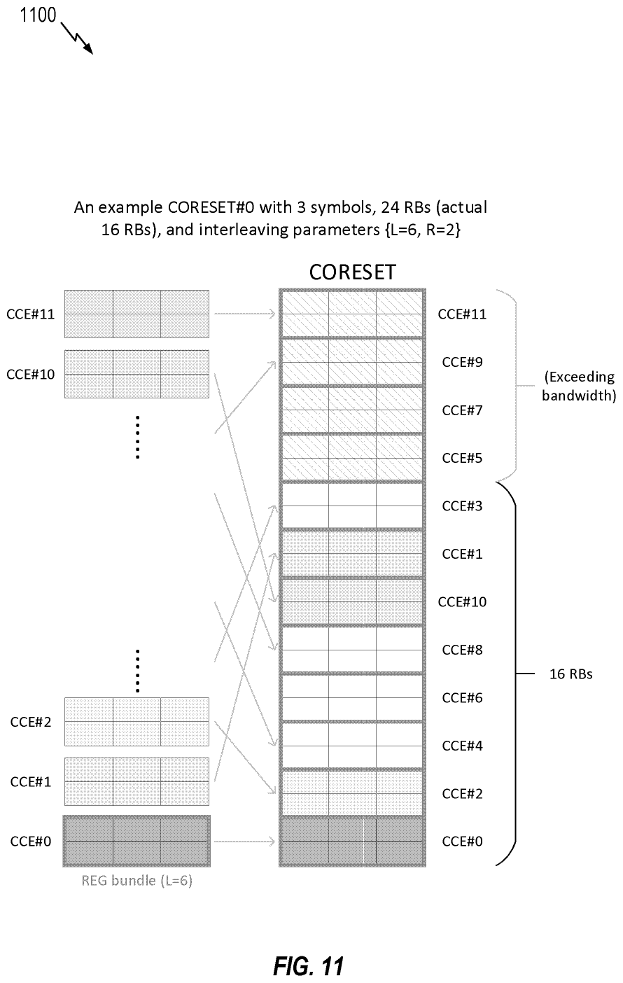

Reusing current MIB signaled CORESET 0 sizes of at least 24 RBs for a PDCCH candidate when only 16 RBs of CORESET 0 space would result in a waste of resources, as the exceeded part of a PDCCH candidate would be punctured (not transmitted). This is illustrated in diagram 1100 of FIG. 11, which shows CCE-to-REG mapping for an example CORESET 0 with 3 symbols and 24 RBs (assuming interleaving parameters {L=6, R=2}) and that only 16 RBs are needed. As illustrated, the standard CCE-to-REG mapping for CORESET 0 results in 4 CCEs (CCE #5, CCE #7, CCE #9, and CCE #11) being mapped to bandwidth beyond the first 16 RBs (these are referred to as exceeding bandwidth). Thus, even though a CORESET of 16 RBs could support a maximum AL of 8 (for 3-symbol CORESET #0), it may only be able to support a lesser AL (e.g., AL 6) due to the mapping of certain CCEs to the excess bandwidth. For example, a PDCCH candidate (AL=8) with CCE #0-to- #7 may always have CCE #5 and #7 outside the system bandwidth (assuming higher-index RBs are punctured). This may result in reduced coverage and degrade the reliability of the common PDCCH in CORESET 0.

### Aspects Related to Control Resource Set Mapping Design

Aspects of the present disclosure provide techniques that may be used to more efficiently map PDCCH candidates to resources of CORESET 0.

As will be described in greater detail below, in some cases, fields in a MIB may be reinterpreted by UEs when operating in certain operating bandwidths (e.g., less than 5 MHZ). These fields may be used to indicate CORESET #0 sizes of less than 24 RBs and may also (or alternatively) enable flexibility to indicate parameters that more efficiently map resources of PDCCH candidates to CORESET #0 resources (e.g., relative to conventional mapping that assumes fixed interleaving parameters). Thus, the techniques presented herein may result in more efficient use of system resources and improved system performance.

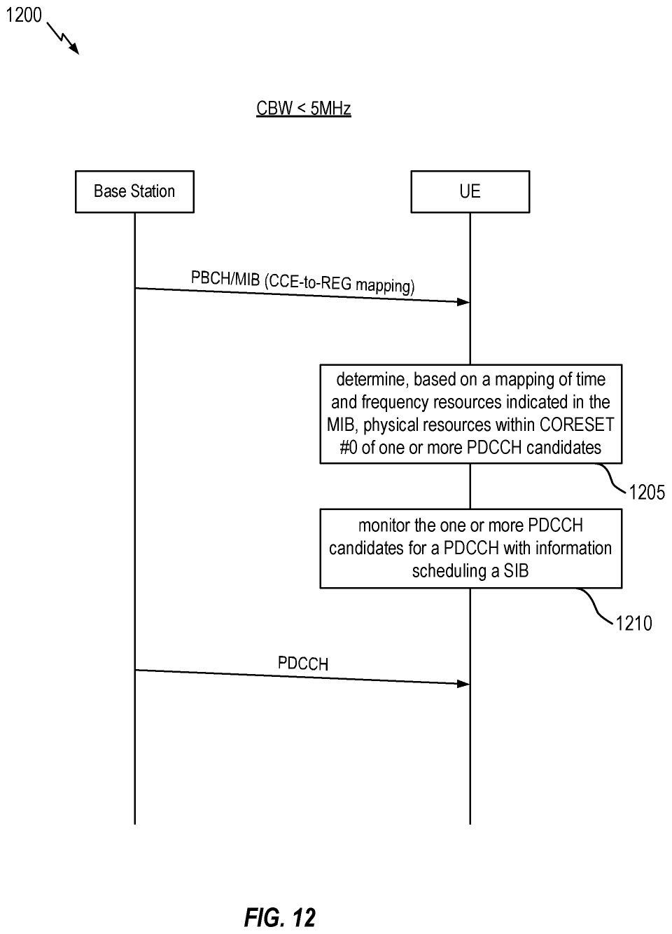

CORESET resource mapping techniques proposed herein may be understood with reference to the example call flow diagram 1200 of FIG. 12. The example shows a base station (e.g., BS 102 of FIGS. 1 and 2, such as a gNB) and a UE (e.g., UE 104 of FIGS. 1 and 2).

As illustrated, the BS may transmit (broadcast) a physical broadcast channel (PBCH) that conveys a master information block (MIB). For example, the MIB may be conveyed via a PBCH in an SSB. The MIB may configure a first CORESET (e.g., CORESET 0) within an operating bandwidth below a threshold bandwidth. For example, the BS and UE may communicate using a reduced bandwidth, for example, reduced relative to 5 MHz bandwidth of NR.

At 1205, the UE may determine physical resources within the first CORESET of one or more physical downlink control channel (PDCCH) candidates, based on a mapping of time and frequency resources indicated in the MIB. At 1210, the UE monitors the one or more PDCCH candidates for a PDCCH with information scheduling a system information block (SIB). This SIB may, in turn, include information that configures another CORESET (other than CORESET 0).

Aspects of the present disclosure provide various options for configuring CORESET 0 to allow for efficient mapping of PDCCH candidates resources to CORESET 0 resources. According to one option, the MIB may indicate time-domain repetition of CORESET 0 with more resources, which may help enhance PDCCH coverage. In some cases, the MIB may indicate an existing CORESET 0 size (e.g., 24 RBs), but may indicate a modified CCE-to-REG mapping to reduce the punctured (wasted) resources for a PDCCH candidate. In some cases, the MIB may indicate a new CORESET 0 size (e.g., less than 24 RBs) that may be more suitable to the narrow bandwidth.

Some or all of these options may provide a MIB/PBCH design that takes advantage of the ability of compatible UEs (e.g., specialized UEs operating in narrowband), to interpret CORESET 0 configuration fields of (indicated by) the MIB differently than other (e.g., conventional NR) UEs.

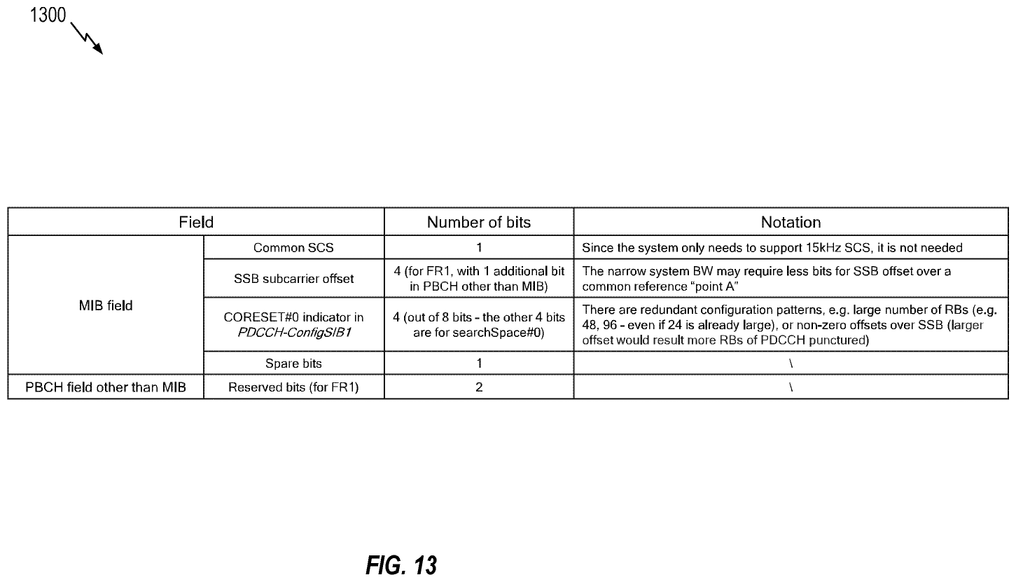

As illustrated in table 1300 of FIG. 13, such fields (e.g., that may be used to indicate how to map PDCCH candidate resources to CORESET resources) may include a Common SCS field, SSB subcarrier offset field, CORESET #0 indicator in PDCCH-ConfigSIB1, spare bits, and/or bits previously reserved for a PBCH field other than MIB. A common SCS bit may be used as an indication, for example, as the system may only need to support one SCS (e.g., 15 kHz SCS). One or more SSB subcarrier offset field bits may be used as an indication, since narrow system BW may require less bits for SSB offset relative to a common reference point (point A). Bits in the CORESET #0 indicator in PDCCH-ConfigSIB1 may be used as there are redundant configuration patterns with large number of RBs (e.g., 48, 96—when even if 24 is already large) or non-zero offsets over SSB (where a larger offset would result more RBs of PDCCH punctured).

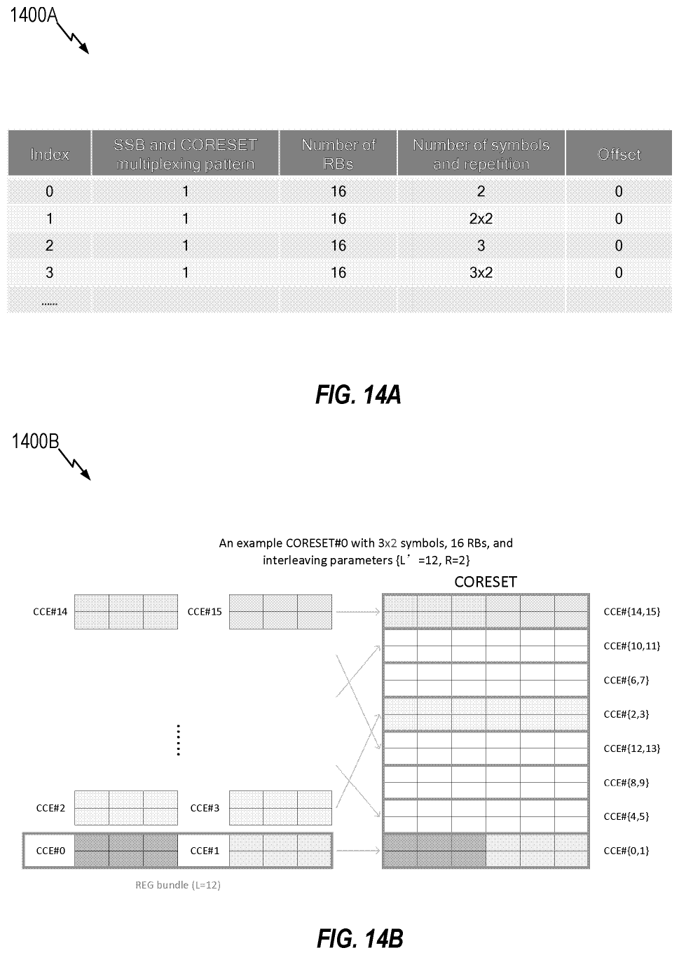

FIG. 14A illustrates how PDCCH-ConfigSIB1 bits may be used as an index into table 1400A, in order to select a configuration that includes a field that indicates time-domain repetition (a form of aggregation) of CORESET 0 with more resources, by specifying a repetition factor N. For example, 4 bits of PDCCH-ConfigSIB1 may be used to select one of 16 entries (0-15). In the illustrated example, index 0 specifies 2 symbols and no repetition (N=0), index 1 specifies 2 symbols with a repetition factor N of 2 (2×2), index 2 specifies 3 symbols and no repetition, while index 3 specifies 3 symbols and a repetition factor N of 2 (3×2). Other index values may, of course, specify other combinations of symbols and repetition factors.

As illustrated by diagram 1400B of FIG. 14B, for CCE-to-REG interleaving, the repetition factor N may effectively increase the REG bundle size used. For example, relative to a conventional REG bundle size L, a new REG bundle size L′ may be enlarged N times (N is the repetition factor in time-domain). For example, for the conventional default REG bundle size of L=6 for CORESET 0 and a repetition factor N=2, L′ may be 12. As illustrated, based on the new REG bundle size L′, interleaving may still be done only in the frequency-domain (the example assumes an interleaving depth of R=2). As illustrated, given the enlarged REG bundled size, the resulting REG bundle may contain resources from multiple CCEs (e.g., one bundle of size 12 includes 6 REGs each from CCE #0 and CCE #1). In some cases, to form REG bundles, CCEs should be time-first indexed. For the illustrated example, this means mapping CCE #0 and CCE #1 in time, then move up in frequency to map CCE #2 and CCE #3, and continuing this up to CCE #14 and CCE #15.

In some cases, the MIB may indicate a new interleaving pattern for CORESET 9. In some cases, a bit or field may be used to indicate different interleaving patterns with different value(s) of REG bundle size L and/or interleaving depth R.

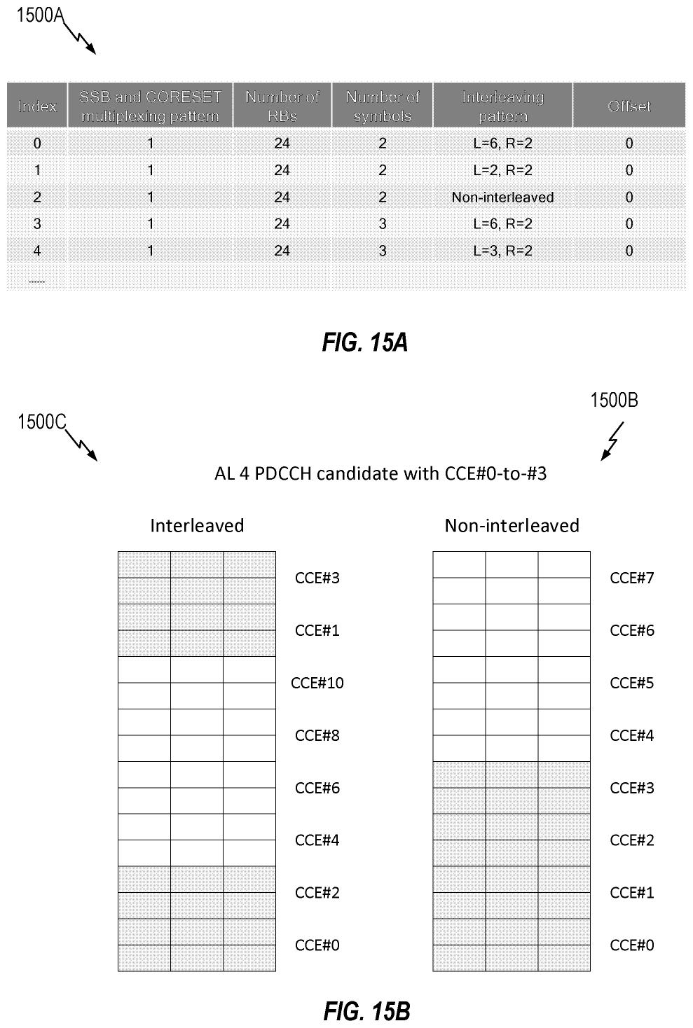

In some cases, the interleaving pattern can be indicated by CORESET #0 indicator in PDCCH-ConfigSIB1. For example, as illustrated in the table 1500A of FIG. 15A, PDCCH-ConfigSIB1 bits may be used as an index into table 1500A, in order to select configurations with different interleaving patterns. In the illustrated example, index 0 selects an interleaving pattern of L=6 and R=2, index 1 selects an interleaving pattern of L=2 and R=2, index 2 selects no interleaving, index 3 selects an interleaving pattern of L=6 and R=2, while index 4 selects an interleaving pattern of L=3 and R=2. The particular combinations of values for L and R may be designed to try and reduce the punctured resources for a give CORESET configuration (e.g., L=2 for 2-symbol CORESET #0, L=3 for 3-symbol CORESET #0).

As illustrated by the example of index 2, non-interleaved may be considered a simple new interleaving pattern for CORESET 0 (rather than conventional parameters of L=6 and R=2) CCE-to-REG mapping. As illustrated in 1500B of FIG. 15B, for AL 4 PDCCH candidates, a non-interleaved pattern would result in CCE #0 to CCE #7 mapped in indexed order within the bandwidth. One potential drawback of this non-interleaved approach is a loss of frequency diversity for smaller aggregation levels. For example, the example assumes aggregation level 4 (AL 4), which results in no frequency diversity in the non-interleaved case. With interleaving, however, CCEs for the two PDCCH candidates are spread over frequency as illustrated by 1500C of FIG. 15B. In some case, MIB could have a bit that indicates whether interleaving is to be used or not (e.g., this could be indicated via the 1-bit MIB/PBCH field of common SCS).

Aspects of the present disclosure may also help determine a frequency domain resource allocation (FDRA) for a physical downlink shared channel (PDSCH) scheduled by DCI conveyed via one of the PDCCH candidates, for example, based on a start and length indicator vector (SLIV) and the operating bandwidth. For example, the FDRA may be determined for a PDSCH during initial access, such as a SIB1 or a random access channel (RACH) message, such as msg2 or msg4.

In conventional systems, a SLIV-based FDRA of DCI for scheduling PDSCH during initial access, is based on the CORESET 0 bandwidth. However, as noted above, in some cases CORESET 0 size can cause a wasted bit in an FDRA field of DCI (e.g., if not modified it can be larger than the actual bandwidth). In other words, if a finer resolution is not used, larger values of the FDRA field that require the highest bit may not be needed. For example, an actual BW of 16 RBs may need only an 8-bit FDRA, while a conventional minimum CORESET 0 size of 24 RBs may need a 9-bit FDRA. Thus, a one bit DCI overhead reduction may be achieved.

According to certain aspects of the present disclosure, (granularity of) the SLIV-based FDRA of PDSCH may be based on the available system bandwidth. In some cases, the available system bandwidth may be indicated by the SSB subcarrier offset field in MIB. In some cases, a UE may be able to pre-determine a fixed available system bandwidth. In any case, indicating the available system bandwidth may be useful, for example, allowing one UE modem product to be adaptive to multiple configurations of different system bandwidths.

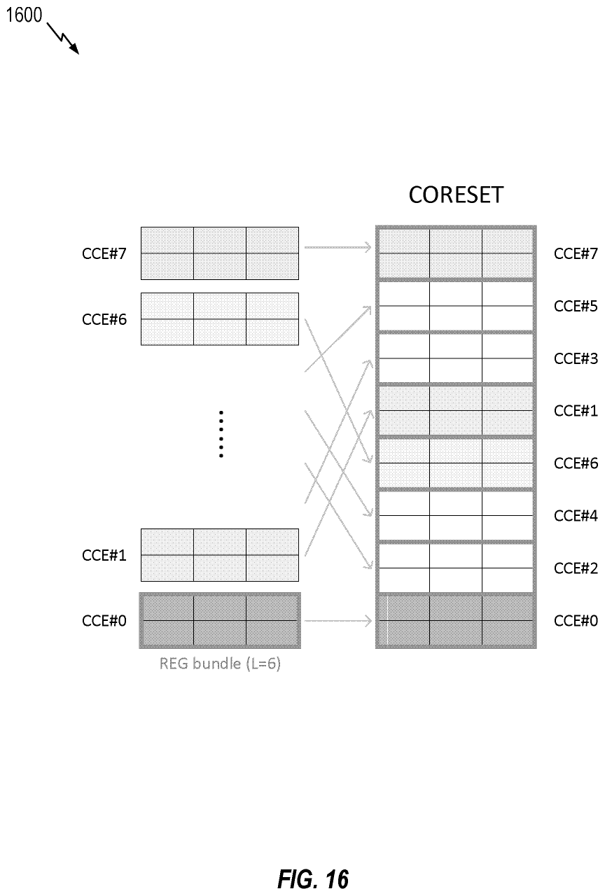

According to certain aspects, a CORESET 0 size may be defined as a minimum value of: a value indicated in PDCCH-ConfigSIB1; and the available bandwidth. As noted above, the available bandwidth may be pre-defined (e.g., for a specially customized UE) or may be indicated via MIB. FIG. 16 illustrates a simple example 1600 where this approach may result in the CORESET 0 size (of 16 RBs) matching the CCEs of the PDCCH candidates and avoid resource waste.

According to certain aspects, new AL values (not supported in normal NR system) may be designed for CORESET 0. The new AL values may be designed to try and reduce the punctured resources for a give CORESET configuration. For example, AL 6 may be defined for a CORESET 0 size of 20-RB and 2-symbols. Similarly, AL 12 may be defined for a CORESET 0 size of 24-RB and 3-symbols (e.g., in cases where AL 16 cannot be supported).

Certain aspects of the present disclosure may also be applied to CORESETs other than CORESET 0 (e.g., for dedicated CORESETs configured via SIB after RRC connection is established. In conventional RRC configurations for a dedicated CORESET, a parameter to used indicate frequency resources (frequencyDomainResources) has 45 bits. Each bit represents 6 consecutive physical resource blocks (PRBs), such that a resource configuration of up to 270 RBs (6×45) can be configured.

For reduced bandwidth, aspects of the present disclosure may provide for a finer granularity for such a bitmap configuration. For example, aspects of the present disclosure may allow for a granularity of 2 RBs for each bit. In addition, or as an alternative, RRC signaling overhead may be reduced by reducing the number of bits used for the bitmap. For example, rather than 45 bits, 26 bits may be sufficient for bandwidths of 5 MHz or less. Such a reduction in bits may be used independently or combined with a finer granularity for greater flexibility.

### Example Methods

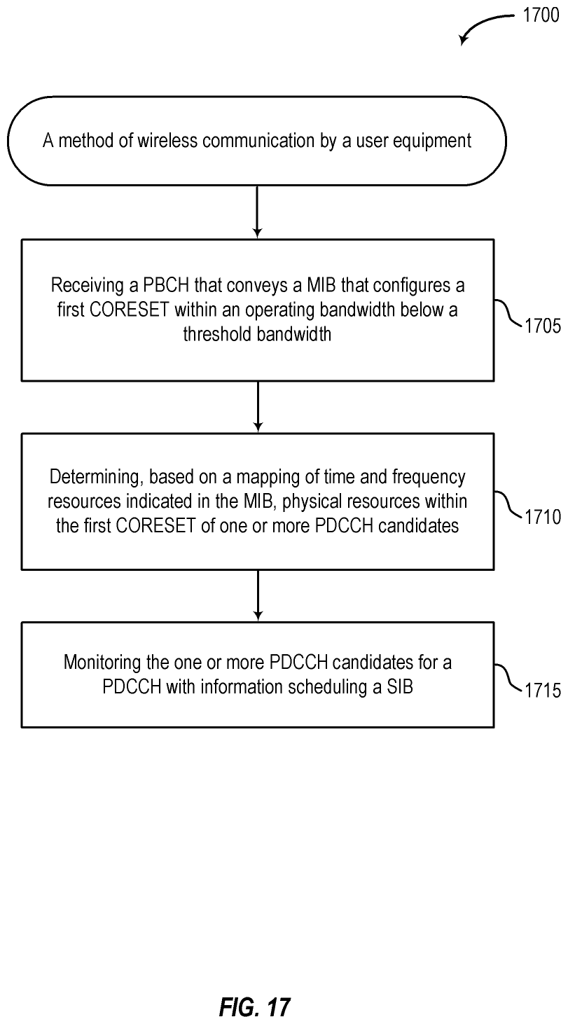

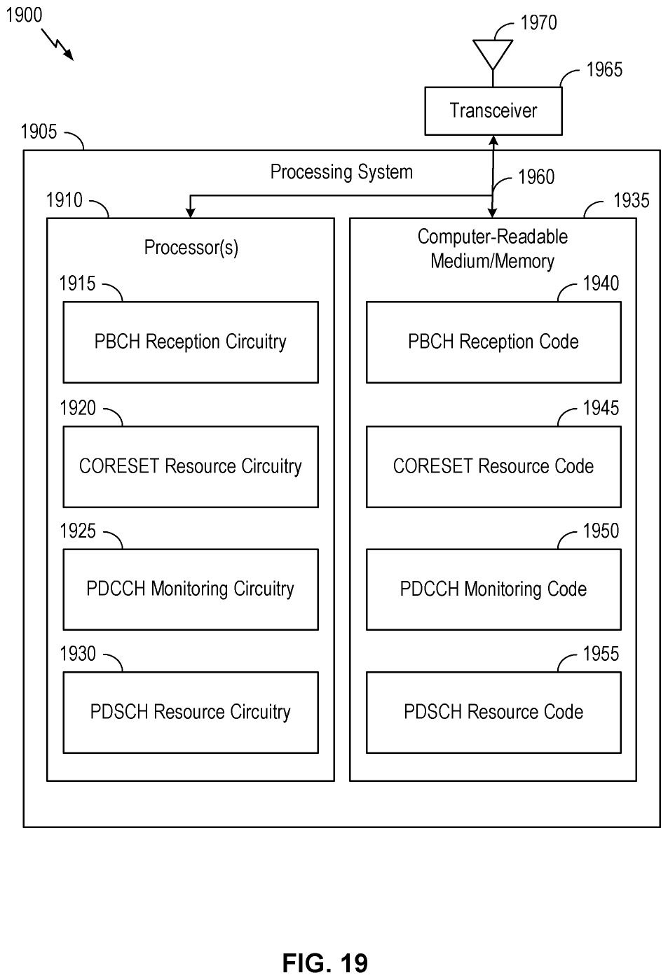

FIG. 17 shows an example of a method 1700 for wireless communication according to aspects of the present disclosure. In some aspects, a user equipment, such as UE 104 of FIGS. 1 and 2, or processing system 1905 of FIG. 19, may perform the method 1700.

Method 1700 begins at step 1705 with receiving a PBCH that conveys a MIB that configures a first CORESET within an operating bandwidth below a threshold bandwidth. In some cases, the operations of this step refer to, or may be performed by, PBCH reception circuitry as described with reference to FIG. 19.

Method 1700 then proceeds to step 1710 with determining, based on a mapping of time and frequency resources indicated in the MIB, physical resources within the first CORESET of one or more PDCCH candidates. In some cases, the operations of this step refer to, or may be performed by, CORESET resource circuitry as described with reference to FIG. 19.

Method 1700 then proceeds to step 1715 with monitoring the one or more PDCCH candidates for a PDCCH with information scheduling a SIB. In some cases, the operations of this step refer to, or may be performed by, PDCCH monitoring circuitry as described with reference to FIG. 19.

In some aspects, the threshold bandwidth is 5 MHz or less. In some aspects, the mapping is indicated by an index formed by one or more bits of a SIB PDCCH configuration field of the MIB. In some aspects, the mapping comprises a CCE to REG mapping.

In some aspects, the mapping is based on an indication in the MIB of a repetition factor that determines a number of symbols the CORESET spans. In some aspects, the mapping involves CCE to REG interleaving that depends on an REG bundle size determined based on the repetition factor. In some aspects, the REG bundle size determined based on the repetition factor allows for REG bundles that contain resources from multiple CCEs.

In some aspects, the mapping is based on an indication in the MIB of an interleaving pattern for CCE to REG interleaving. In some aspects, the MIB includes a bit indicating whether or not CCE to REG interleaving is used. In some aspects, the indication of the interleaving pattern is via an index that selects the interleaving pattern from a plurality of different interleaving patterns that differ in at least one of an REG bundle size or interleaving depth.

In some aspects, method 1700 further includes determining a FDRA for a physical downlink shared channel scheduled by one of the PDCCH candidates, based on a SLIV and the operating bandwidth. In some aspects, method 1700 further includes determining the operating bandwidth via a field in the MIB.

In some aspects, method 1700 further includes determining a size of the first CORESET based on at least one of an indication in the MIB or the operating bandwidth.

In some aspects, method 1700 further includes determining one or more ALs for the PDCCH candidates based on a size of at least one of time or frequency resources of the first CORESET.

In some aspects, method 1700 further includes determining, based on the operating bandwidth, at least one of a size or granularity for a parameter indicating frequency resources for a second CORESET.

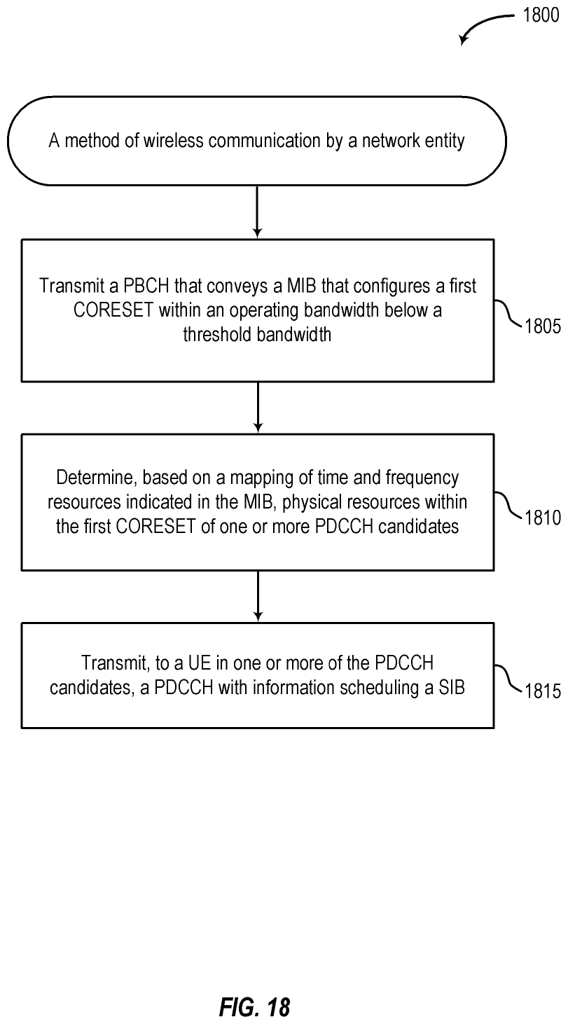

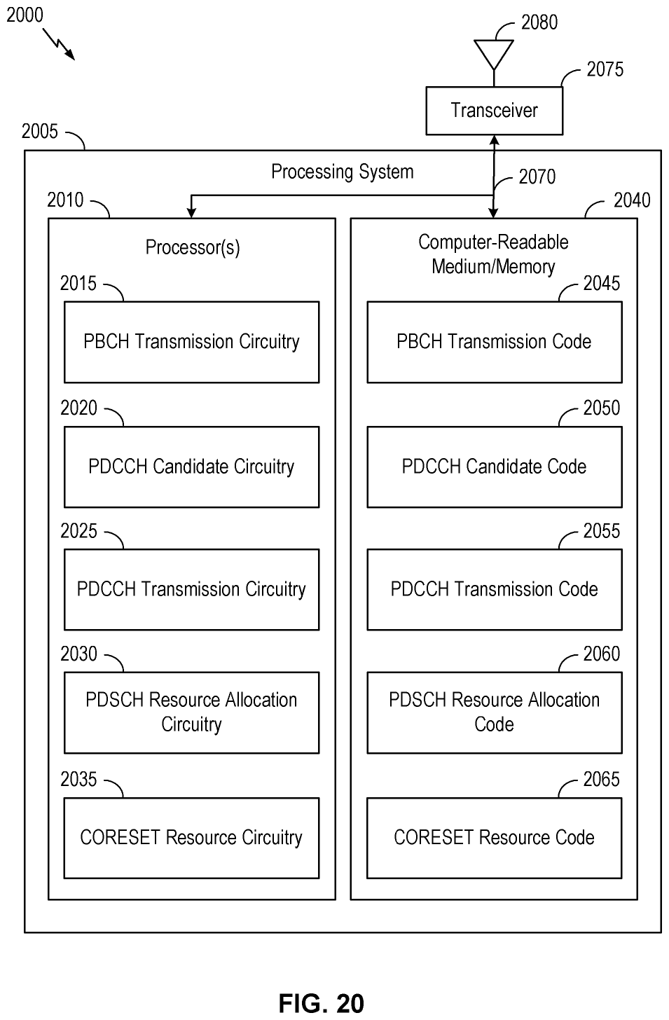

FIG. 18 shows an example of a method 1800 for wireless communication according to aspects of the present disclosure. In some aspects, a base station, such as BS 102 of FIGS. 1 and 2, or processing system 2005 of FIG. 20, may perform the method 1800.

Method 1800 begins at step 1805 with transmitting a PBCH that conveys a MIB that configures a first CORESET within an operating bandwidth below a threshold bandwidth. In some cases, the operations of this step refer to, or may be performed by, PBCH transmission circuitry as described with reference to FIG. 20.

Method 1800 then proceeds to step 1810 with determining, based on a mapping of time and frequency resources indicated in the MIB, physical resources within the first CORESET of one or more PDCCH candidates. In some cases, the operations of this step refer to, or may be performed by, PDCCH candidate circuitry as described with reference to FIG. 20.

Method 1800 then proceeds to step 1815 with system transmitting, to a UE in one or more of the PDCCH candidates, a PDCCH with information scheduling a SIB. In some cases, the operations of this step refer to, or may be performed by, PDCCH transmission circuitry as described with reference to FIG. 20.

In some aspects, the threshold bandwidth is 5 MHz or less. In some aspects, the mapping is indicated by an index formed by one or more bits of a SIB PDCCH configuration field of the MIB.

In some aspects, the mapping comprises a CCE to REG mapping. In some aspects, the mapping is based on an indication in the MIB of a repetition factor that determines a number of symbols the CORESET spans. In some aspects, the mapping involves CCE to REG interleaving that depends on an REG bundle size determined based on the repetition factor. In some aspects, the REG bundle size determined based on the repetition factor allows for REG bundles that contain resources from multiple CCEs.

In some aspects, the mapping is based on an indication in the MIB of an interleaving pattern for CCE to REG interleaving. In some aspects, the MIB includes a bit indicating whether or not CCE to REG interleaving is used. In some aspects, the indication of the interleaving pattern is via an index that selects the interleaving pattern from a plurality of different interleaving patterns that differ in at least one of an REG bundle size or interleaving depth.

In some aspects, method 1800 further includes determining a FDRA for a physical downlink shared channel scheduled by one of the PDCCH candidates, based on a SLIV and the operating bandwidth. In some aspects, method 1800 further includes indicating, to the UE, the operating bandwidth via a field in the MIB.

In some aspects, method 1800 further includes indicating, to the UE, a size of the first CORESET via an indication in the MIB.

In some aspects, method 1800 further includes determining one or more ALs for the PDCCH candidates based on a size of at least one of time or frequency resources of the first CORESET.

In some aspects, method 1800 further includes determining, based on the operating bandwidth, at least one of a size or granularity for a parameter indicating frequency resources for a second CORESET.

### Example Wireless Communication Device

FIG. 19 depicts an example communications device 1900 that includes various components operable, configured, or adapted to perform operations for the techniques disclosed herein, such as the operations depicted and described with respect to FIGS. 12 and 17. In some examples, communication device 1900 may be a UE 104 as described, for example with respect to FIGS. 1 and 2.

Communications device 1900 includes a processing system 1905 coupled to the transceiver 1965 (e.g., a transmitter and/or a receiver). The transceiver 1965 is configured to transmit (or send) and receive signals for the communications device 1900 via the antenna 1970, such as the various signals as described herein. The transceiver 1965 may communicate bi-directionally, via the antennas 1970, wired links, or wireless links as described herein. For example, the transceiver 1965 may represent a wireless transceiver and may communicate bi-directionally with another wireless transceiver. The transceiver 1965 may also include or be connected to a modem to modulate the packets and provide the modulated packets to for transmission, and to demodulate received packets. In some examples, the transceiver 1965 may be tuned to operate at specified frequencies. For example, a modem can configure the transceiver 1965 to operate at a specified frequency and power level based on the communication protocol used by the modem.

Processing system 1905 may be configured to perform processing functions for communications device 1900, including processing signals received and/or to be transmitted by communications device 1900. Processing system 1905 includes one or more processors 1910 coupled to a computer-readable medium/memory 1935 via a bus 1960.

In some examples, one or more processors 1910 may include one or more intelligent hardware devices, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the one or more processors 1910 are configured to operate a memory array using a memory controller. In other cases, a memory controller is integrated into the one or more processors 1910. In some cases, the one or more processors 1910 are configured to execute computer-readable instructions stored in a memory to perform various functions. In some aspects, one or more processors 1910 include special purpose components for modem processing, baseband processing, digital signal processing, or transmission processing.

In certain aspects, computer-readable medium/memory 1935 is configured to store instructions (e.g., computer-executable code) that when executed by the one or more processors 1910, cause the one or more processors 1910 to perform the operations illustrated in FIGS. 12 and 17, or other operations for performing the various techniques discussed herein.

In one aspect, computer-readable medium/memory 1935 includes PBCH reception code 1940, CORESET resource code 1945, PDCCH monitoring code 1950, and PDSCH resource code 1955.

Examples of a computer-readable medium/memory 1935 include random access memory (RAM), read-only memory (ROM), solid state memory, a hard drive, a hard disk drive, etc. In some examples, computer-readable medium/memory 1935 is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

Various components of communications device 1900 may provide means for performing the methods described herein, including with respect to FIGS. 12 and 17.

In some examples, means for transmitting or sending (or means for outputting for transmission) may include transceivers 254 and/or antenna(s) 252 of the UE 104 illustrated in FIG. 2 and/or the transceiver 1965 and the antenna 1970 of the communication device in FIG. 19.

In some examples, means for receiving (or means for obtaining) may include transceivers 254 and/or antenna(s) 252 of the UE 104 illustrated in FIG. 2 and/or the transceiver 1965 and the antenna 1970 of the communication device in FIG. 19.

In some examples, means for performing various operations described herein may include various processing system 1905 components, such as: the one or more processors 1910 in FIG. 19, or aspects of the UE 104 depicted in FIG. 2, including receive processor 258, transmit processor 264, TX MIMO processor 266, and/or controller/processor 280 (including CORESET mapping component 281).

In one aspect, one or more processors 1910 includes PBCH reception circuitry 1915, CORESET resource circuitry 1920, PDCCH monitoring circuitry 1925, and PDSCH resource circuitry 1930.

According to some aspects, PBCH reception circuitry 1915 receives a PBCH that conveys a MIB that configures a first CORESET within an operating bandwidth below a threshold bandwidth. In some aspects, the threshold bandwidth is 5 MHz or less.

According to some aspects, CORESET resource circuitry 1920 determines, based on a mapping of time and frequency resources indicated in the MIB, physical resources within the first CORESET of one or more PDCCH candidates. In some aspects, the mapping is indicated by an index formed by one or more bits of a SIB PDCCH configuration field of the MIB. In some aspects, the mapping includes a CCE to REG mapping. In some aspects, the mapping is based on an indication in the MIB of a repetition factor that determines a number of symbols the CORESET spans.

In some aspects, the mapping involves CCE to REG interleaving that depends on an REG bundle size determined based on the repetition factor. In some aspects, the REG bundle size determined based on the repetition factor allows for REG bundles that contain resources from multiple CCEs. In some aspects, the mapping is based on an indication in the MIB of an interleaving pattern for CCE to REG interleaving. In some aspects, the MIB includes a bit indicating whether or not CCE to REG interleaving is used. In some aspects, the indication of the interleaving pattern is via an index that selects the interleaving pattern from a set of different interleaving patterns that differ in at least one of an REG bundle size or interleaving depth.

In some examples, CORESET resource circuitry 1920 determines a size of the first CORESET based on at least one of an indication in the MIB or the operating bandwidth. In some examples, CORESET resource circuitry 1920 determines, based on the operating bandwidth, at least one of a size or granularity for a parameter indicating frequency resources for a second CORESET.

According to some aspects, PDCCH monitoring circuitry 1925 monitors the one or more PDCCH candidates for a PDCCH with information scheduling a SIB. In some examples, PDCCH monitoring circuitry 1925 determines one or more ALs for the PDCCH candidates based on a size of at least one of time or frequency resources of the first CORESET.

According to some aspects, PDSCH resource circuitry 1930 determines a FDRA for a physical downlink shared channel scheduled by one of the PDCCH candidates, based on a SLIV and the operating bandwidth. In some examples, CORESET resource circuitry 1920 determines the operating bandwidth via a field in the MIB.

Notably, FIG. 19 is just one example, and many other examples and configurations of communication device are possible.

FIG. 20 depicts an example communications device 2000 that includes various components operable, configured, or adapted to perform operations for the techniques disclosed herein, such as the operations depicted and described with respect to FIGS. 12 and 18. In some examples, communication device may be a BS 102 as described, for example with respect to FIGS. 1 and 2.

Communications device 2000 includes a processing system 2005 coupled to the transceiver 2075 (e.g., a transmitter and/or a receiver). The transceiver 2075 is configured to transmit (or send) and receive signals for the communications device 2000 via the antenna 2080, such as the various signals as described herein. The transceiver 2075 may communicate bi-directionally, via the antennas 2080, wired links, or wireless links as described herein. For example, the transceiver 2075 may represent a wireless transceiver and may communicate bi-directionally with another wireless transceiver. The transceiver 2075 may also include or be connected to a modem to modulate the packets and provide the modulated packets to for transmission, and to demodulate received packets. In some examples, the transceiver 2075 may be tuned to operate at specified frequencies. For example, a modem can configure the transceiver 2075 to operate at a specified frequency and power level based on the communication protocol used by the modem.

Processing system 2005 may be configured to perform processing functions for communications device 2000, including processing signals received and/or to be transmitted by communications device 2000. Processing system 2005 includes one or more processors 2010 coupled to a computer-readable medium/memory 2040 via a bus 2070.

In some examples, one or more processors 2010 may include one or more intelligent hardware devices, (e.g., a general-purpose processing component, a DSP, a CPU, a GPU, a microcontroller, an ASIC, a FPGA, a programmable logic device, a discrete gate or transistor logic component, a discrete hardware component, or any combination thereof). In some cases, the one or more processors 2010 are configured to operate a memory array using a memory controller. In other cases, a memory controller is integrated into the one or more processors 2010. In some cases, the one or more processors 2010 are configured to execute computer-readable instructions stored in a memory to perform various functions. In some aspects, one or more processors 2010 include special purpose components for modem processing, baseband processing, digital signal processing, or transmission processing.

In certain aspects, computer-readable medium/memory 2040 is configured to store instructions (e.g., computer-executable code) that when executed by the one or more processors 2010, cause the one or more processors 2010 to perform the operations illustrated in FIGS. 12 and 18, or other operations for performing the various techniques discussed herein.

In one aspect, computer-readable medium/memory 2040 includes PBCH transmission code 2045, PDCCH candidate code 2050, PDCCH transmission code 2055, PDSCH resource allocation code 2060, and CORESET resource code 2065.

Examples of a computer-readable medium/memory 2040 include RAM, ROM, solid state memory, a hard drive, a hard disk drive, etc. In some examples, computer-readable medium/memory 2040 is used to store computer-readable, computer-executable software including instructions that, when executed, cause a processor to perform various functions described herein. In some cases, the memory contains, among other things, a BIOS which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

Various components of communications device 2000 may provide means for performing the methods described herein, including with respect to FIGS. 12 and 18.

In some examples, means for transmitting or sending (or means for outputting for transmission) may include transceivers 232 and/or antenna(s) 234 of the BS 102 illustrated in FIG. 2 and/or the transceiver 2075 and the antenna 2080 of the communication device in FIG. 20.

In some examples, means for receiving (or means for obtaining) may include transceivers 232 and/or antenna(s) 234 of the BS 102 illustrated in FIG. 2 and/or the transceiver 2075 and the antenna 2080 of the communication device in FIG. 20.

In some examples, means for performing various operations described herein may include various processing system 2005 components, such as: the one or more processors 2010 in FIG. 20, or aspects of the BS 102 depicted in FIG. 2, including receive processor 238, transmit processor 220, TX MIMO processor 230, and/or controller/processor 240 (including CORESET mapping component 241).

In one aspect, one or more processors 2010 includes PBCH transmission circuitry 2015, PDCCH candidate circuitry 2020, PDCCH transmission circuitry 2025, PDSCH resource allocation circuitry 2030, and CORESET resource circuitry 2035.

According to some aspects, PBCH transmission circuitry 2015 transmits a PBCH that conveys a MIB that configures a first CORESET within an operating bandwidth below a threshold bandwidth. In some aspects, the threshold bandwidth is 5 MHz or less. In some examples, PBCH transmission circuitry 2015 indicates, to the UE, a size of the first CORESET via an indication in the MIB.

According to some aspects, PDCCH candidate circuitry 2020 determines, based on a mapping of time and frequency resources indicated in the MIB, physical resources within the first CORESET of one or more PDCCH candidates. In some aspects, the mapping is indicated by an index formed by one or more bits of a SIB PDCCH configuration field of the MIB. In some aspects, the mapping includes a CCE to REG mapping. In some aspects, the mapping is based on an indication in the MIB of a repetition factor that determines a number of symbols the CORESET spans. In some aspects, the mapping involves CCE to REG interleaving that depends on an REG bundle size determined based on the repetition factor. In some aspects, the REG bundle size determined based on the repetition factor allows for REG bundles that contain resources from multiple CCEs.

In some aspects, the mapping is based on an indication in the MIB of an interleaving pattern for CCE to REG interleaving. In some aspects, the MIB includes a bit indicating whether or not CCE to REG interleaving is used. In some aspects, the indication of the interleaving pattern is via an index that selects the interleaving pattern from a set of different interleaving patterns that differ in at least one of an REG bundle size or interleaving depth.

In some examples, PDCCH candidate circuitry 2020 determines one or more ALs for the PDCCH candidates based on a size of at least one of time or frequency resources of the first CORESET.

According to some aspects, PDCCH transmission circuitry 2025 transmits, to a UE in one or more of the PDCCH candidates, a PDCCH with information scheduling a SIB.

According to some aspects, PDSCH resource allocation circuitry 2030 determines a FDRA for a physical downlink shared channel scheduled by one of the PDCCH candidates, based on a SLIV and the operating bandwidth. In some examples, PBCH transmission circuitry 2015 indicates, to the UE, the operating bandwidth via a field in the MIB.

According to some aspects, CORESET resource circuitry 2035 determines, based on the operating bandwidth, at least one of a size or granularity for a parameter indicating frequency resources for a second CORESET.

Notably, FIG. 20 is just one example, and many other examples and configurations of communication device are possible.

### Example Clauses

Implementation examples are described in the following numbered clauses:

Clause 1: A method of wireless communication by a user equipment, the method comprising: receiving a PBCH that conveys a MIB that configures a first CORESET within an operating bandwidth below a threshold bandwidth; determining, based on a mapping of time and frequency resources indicated in the MIB, physical resources within the first CORESET of one or more PDCCH candidates; and monitoring the one or more PDCCH candidates for a PDCCH with information scheduling a SIB.

Clause 2: The method of Clause 1, wherein the threshold bandwidth is 5 MHz or less.

Clause 3: The method of any one of Clauses 1 and 2, wherein the mapping is indicated by an index formed by one or more bits of a SIB PDCCH configuration field of the MIB.

Clause 4: The method of any one of Clauses 1-3, wherein the mapping comprises a CCE to REG mapping.

Clause 5: The method of Clause 4, wherein the mapping is based on an indication in the MIB of a repetition factor that determines a number of symbols the CORESET spans.

Clause 6: The method of Clause 5, wherein the mapping involves CCE to REG interleaving that depends on an REG bundle size determined based on the repetition factor.

Clause 7: The method of Clause 6, wherein the REG bundle size determined based on the repetition factor allows for REG bundles that contain resources from multiple CCEs.

Clause 8: The method of Clause 4, wherein the mapping is based on an indication in the MIB of an interleaving pattern for CCE to REG interleaving.

Clause 9: The method of Clause 8, wherein the MIB includes a bit indicating whether or not CCE to REG interleaving is used.

Clause 10: The method of Clause 8, wherein the indication of the interleaving pattern is via an index that selects the interleaving pattern from a plurality of different interleaving patterns that differ in at least one of an REG bundle size or interleaving depth.

Clause 11: The method of any one of Clauses 1-10, further comprising: determining a FDRA for a physical downlink shared channel scheduled by one of the PDCCH candidates, based on a SLIV and the operating bandwidth.

Clause 12: The method of Clause 11, wherein the method further comprises: determining the operating bandwidth via a field in the MIB.

Clause 13: The method of any one of Clauses 1-12, further comprising: determining a size of the first CORESET based on at least one of an indication in the MIB or the operating bandwidth.

Clause 14: The method of any one of Clauses 1-13, further comprising: determining one or more ALs for the PDCCH candidates based on a size of at least one of time or frequency resources of the first CORESET.

Clause 15: The method of any one of Clauses 1-14, further comprising: determining, based on the operating bandwidth, at least one of a size or granularity for a parameter indicating frequency resources for a second CORESET.

Clause 16: A method of wireless communication by a network entity, the method comprising: transmitting a PBCH that conveys a MIB that configures a first CORESET within an operating bandwidth below a threshold bandwidth; determining, based on a mapping of time and frequency resources indicated in the MIB, physical resources within the first CORESET of one or more PDCCH candidates; and transmitting, to a UE in one or more of the PDCCH candidates, a PDCCH with information scheduling a SIB.

Clause 17: The method of Clause 16, wherein the threshold bandwidth is 5 MHz or less.

Clause 18: The method of any one of Clauses 16 and 17, wherein the mapping is indicated by an index formed by one or more bits of a SIB PDCCH configuration field of the MIB.

Clause 19: The method of any one of Clauses 16-18, wherein the mapping comprises a CCE to REG mapping.

Clause 20: The method of Clause 19, wherein the mapping is based on an indication in the MIB of a repetition factor that determines a number of symbols the CORESET spans.

Clause 21: The method of Clause 20, wherein the mapping involves CCE to REG interleaving that depends on an REG bundle size determined based on the repetition factor.

Clause 22: The method of Clause 21, wherein the REG bundle size determined based on the repetition factor allows for REG bundles that contain resources from multiple CCEs.

Clause 23: The method of Clause 19, wherein the mapping is based on an indication in the MIB of an interleaving pattern for CCE to REG interleaving.

Clause 24: The method of Clause 23, wherein the MIB includes a bit indicating whether or not CCE to REG interleaving is used.

Clause 25: The method of Clause 23, wherein the indication of the interleaving pattern is via an index that selects the interleaving pattern from a plurality of different interleaving patterns that differ in at least one of an REG bundle size or interleaving depth.

Clause 26: The method of any one of Clauses 16-25, further comprising: determining a FDRA for a physical downlink shared channel scheduled by one of the PDCCH candidates, based on a SLIV and the operating bandwidth.

Clause 27: The method of Clause 26, further comprising: indicating, to the UE, the operating bandwidth via a field in the MIB.

Clause 28: The method of any one of Clauses 16-27, further comprising: indicating, to the UE, a size of the first CORESET via an indication in the MIB.

Clause 29: The method of any one of Clauses 16-28, further comprising: determining one or more ALs for the PDCCH candidates based on a size of at least one of time or frequency resources of the first CORESET.

Clause 30: The method of any one of Clauses 16-29, further comprising: determining, based on the operating bandwidth, at least one of a size or granularity for a parameter indicating frequency resources for a second CORESET.

Clause 31: A processing system, comprising: a memory comprising computer-executable instructions; one or more processors configured to execute the computer-executable instructions and cause the processing system to perform a method in accordance with any one of Clauses 1-30.

Clause 32: A processing system, comprising means for performing a method in accordance with any one of Clauses 1-30.

Clause 33: A non-transitory computer-readable medium comprising computer-executable instructions that, when executed by one or more processors of a processing system, cause the processing system to perform a method in accordance with any one of Clauses 1-30.

Clause 34: A computer program product embodied on a computer-readable storage medium comprising code for performing a method in accordance with any one of Clauses 1-30.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a NodeB and/or a narrowband subsystem serving this coverage area, depending on the context in which the term is used. In NR systems, the term “cell” and BS, next generation NodeB (gNB or gNodeB), access point (AP), distributed unit (DU), carrier, or transmission reception point may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area (e.g., a sports stadium) and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS, home BS, or a home NodeB.

BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as BS 180 (e.g., gNB) may operate in a traditional sub-6 GHz spectrum, in millimeter wave (mmWave) frequencies, and/or near mmWave frequencies in communication with the UE 104. When the BS 180 operates in mmWave or near mmWave frequencies, the BS 180 may be referred to as an mmWave base station.

The communication links 120 between BSs 102 and, for example, UEs 104, may be through one or more carriers. For example, BSs 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communication network 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a PSSCH, and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and may be responsible for session management (start/stop) and for collecting eMBMS related charging information.

5GC 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and 5GC 190. Generally, AMF 192 provides QoS flow and session management.

All user Internet protocol (IP) packets are transferred through UPF 195, which is connected to the IP Services 197, and which provides UE IP address allocation as well as other functions for 5GC 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a PSSCH.

Transmit processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH DMRS, and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a RB, may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A, 3B, 3C, and 3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through RRC signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A, 3B, 3C, and 3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a RB (also referred to as physical RBs (PRBs)) that extends 12 consecutive subcarriers. The resource grid is divided into multiple REs. The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Additional Considerations

The preceding description provides examples of resource mapping for CORESETs in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the physical (PHY) layer. In the case of a user equipment (as in the example UE 104 of FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communication by a user equipment (UE), comprising:
one or more memories comprising executable instructions; and
one or more processors configured to execute the executable instructions and cause the UE to:
receive a physical broadcast channel (PBCH) that conveys a master information block (MIB) that configures a first control resource set (CORESET) within an operating bandwidth below a threshold bandwidth;
determine, based on a mapping of time and frequency resources indicated in the MIB, physical resources within the first CORESET of one or more physical downlink control channel (PDCCH) candidates; and
monitor the one or more PDCCH candidates for a PDCCH with information scheduling a system information block (SIB).

2. The apparatus of claim 1, wherein the threshold bandwidth is 5 MHz or less.

3. The apparatus of claim 1, wherein the mapping is indicated by an index formed by one or more bits of a SIB PDCCH configuration field of the MIB.

4. The apparatus of claim 1, wherein the mapping comprises a control channel element (CCE) to resource element group (REG) mapping.

5. The apparatus of claim 4, wherein the mapping is based on an indication in the MIB of a repetition factor that determines a number of symbols the CORESET spans.

6. The apparatus of claim 5, wherein the mapping involves CCE to REG interleaving that depends on an REG bundle size determined based on the repetition factor.

7. The apparatus of claim 6, wherein the REG bundle size determined based on the repetition factor allows for REG bundles that contain resources from multiple CCEs.

8. The apparatus of claim 4, wherein the mapping is based on an indication in the MIB of an interleaving pattern for CCE to REG interleaving.

9. The apparatus of claim 8, wherein the MIB includes a bit indicating whether or not CCE to REG interleaving is used.

10. The apparatus of claim 8, wherein the indication of the interleaving pattern is via an index that selects the interleaving pattern from a plurality of different interleaving patterns that differ in at least one of an REG bundle size or interleaving depth.

11. The apparatus of claim 1, wherein the one or more processors are further configured to cause the UE to:
determine a frequency domain resource allocation (FDRA) for a physical downlink shared channel scheduled by one of the PDCCH candidates, based on a start and length indicator vector (SLIV) and the operating bandwidth.

12. The apparatus of claim 11, wherein the one or more processors are further configured to cause the UE to:
determine the operating bandwidth via a field in the MIB.

13. The apparatus of claim 1, wherein the one or more processors are further configured to cause the UE to:
determine a size of the first CORESET based on at least one of an indication in the MIB or the operating bandwidth.

14. The apparatus of claim 1, wherein the one or more processors are further configured to cause the UE to:
determine one or more aggregation levels (ALs) for the PDCCH candidates based on a size of at least one of time or frequency resources of the first CORESET.

15. The apparatus of claim 1, wherein the one or more processors are further configured to cause the UE to:
determine, based on the operating bandwidth, at least one of a size or granularity for a parameter indicating frequency resources for a second CORESET.

16. An apparatus for wireless communication by a network entity, comprising:
one or more memories comprising executable instructions; and
one or more processors configured to execute the executable instructions and cause the network entity to:
transmit a physical broadcast channel (PBCH) that conveys a master information block (MIB) that configures a first control resource set (CORESET) within an operating bandwidth below a threshold bandwidth;
determine, based on a mapping of time and frequency resources indicated in the MIB, physical resources within the first CORESET of one or more physical downlink control channel (PDCCH) candidates; and
transmit, to a user equipment (UE) in one or more of the PDCCH candidates, a PDCCH with information scheduling a system information block (SIB).

17. The method of claim 16, wherein the threshold bandwidth is 5 MHz or less.

18. The method of claim 16, wherein the mapping is indicated by an index formed by one or more bits of a SIB PDCCH configuration field of the MIB.

19. The method of claim 16, wherein the mapping comprises a control channel element (CCE) to resource element group (REG) mapping.

20. The method of claim 19, wherein the mapping is based on an indication in the MIB of a repetition factor that determines a number of symbols the CORESET spans.

21. The method of claim 20, wherein the mapping involves CCE to REG interleaving that depends on an REG bundle size determined based on the repetition factor.

22. The method of claim 21, wherein the REG bundle size determined based on the repetition factor allows for REG bundles that contain resources from multiple CCEs.

23. The method of claim 19, wherein the mapping is based on an indication in the MIB of an interleaving pattern for CCE to REG interleaving.

24. The method of claim 23, wherein the MIB includes a bit indicating whether or not CCE to REG interleaving is used.

25. The method of claim 23, wherein the indication of the interleaving pattern is via an index that selects the interleaving pattern from a plurality of different interleaving patterns that differ in at least one of an REG bundle size or interleaving depth.

26. The method of claim 16, wherein the one or more processors are further configured to cause the network entity to:
determine a frequency domain resource allocation (FDRA) for a physical downlink shared channel scheduled by one of the PDCCH candidates, based on a start and length indicator vector (SLIV) and the operating bandwidth.

27. The method of claim 26, wherein the one or more processors are further configured to cause the network entity to:
indicate, to the UE, the operating bandwidth via a field in the MIB.

28. The method of claim 16, wherein the one or more processors are further configured to cause the network entity to:
indicate, to the UE, a size of the first CORESET via an indication in the MIB.

29-34. (canceled)

35. A method of wireless communication by a user equipment (UE), comprising:
receiving a physical broadcast channel (PBCH) that conveys a master information block (MIB) that configures a first control resource set (CORESET) within an operating bandwidth below a threshold bandwidth;
determining, based on a mapping of time and frequency resources indicated in the MIB, physical resources within the first CORESET of one or more physical downlink control channel (PDCCH) candidates; and
monitoring the one or more PDCCH candidates for a PDCCH with information scheduling a system information block (SIB).

36. A method of wireless communication by a network entity, comprising:
transmitting a physical broadcast channel (PBCH) that conveys a master information block (MIB) that configures a first control resource set (CORESET) within an operating bandwidth below a threshold bandwidth;
determining, based on a mapping of time and frequency resources indicated in the MIB, physical resources within the first CORESET of one or more physical downlink control channel (PDCCH) candidates; and
transmitting, to a user equipment (UE) in one or more of the PDCCH candidates, a PDCCH with information scheduling a system information block (SIB).
